(19) United States
(12) Patent Application Publication
(10) Pub. No.: US 2020/0175078 A1
(43) Pub. Date: Jun. 4, 2020

(54) MULTIPLE INTENT INTERPRETER AND RECOMMENDER

(71) Applicant: Hitachi, Ltd., Tokyo (JP)

(72) Inventors: Lounell Bahoy GUETA, Singapore (SG); Akiko SATO, Singapore (SG)

(21) Appl. No.: 16/615,182

(22) PCT Filed: Sep. 11, 2017
(86) PCT No.: PCT/SG2017/050456

§ 371 Date: Nov. 20, 2019

(51) Int. Cl. G06F 16/9032; G06Q 30/06; G06N 5/04; G06N 5/02

(52) U.S. Cl. CPC G06F 16/90332; G06N 5/022; G06N 5/045; G06Q 30/0631

(57) ABSTRACT

A system for interpreting intents and providing recommendations based on the intents is provided. The system may include a multiple-intent interpreter configured to receive a customer expression and interprets a plurality of intents from the expression. The plurality of intents may be processed by the system to discover other related intents from an intent network. In searching the intent network to discover related intents, the intents may be grouped into sets, where each intent set may correspond to one recommendation. The system may further include a recommender that provides a set of recommendations based on a set or sets of intents. Each recommendation may be evaluated with a risk index that is calculated based on news reports, financial data, blogs, and opinion write-ups, which may be available from public domain as well from private domain.

### TECHNICAL FIELD

Various aspects of this disclosure generally relate to knowledge based systems, and more particularly, to recommender systems.

### BACKGROUND

Recommendation or recommender systems have found practical applications in various domains. For instance, recommendation systems have been used to suggest books, personal effects, music and video in online stores, and to provide services by recommending reservations for flight, hotel and other concierge services. Traditional recommender systems however have the following three limitations: (1) firstly, a customer intent has to be expressed in a specific manner; (2) secondly, a recommender system is only designed to cater to one intent or few intents; (3) lastly, the transactions involved in the recommendation entails minimal risk. In contrast, transactions in banking entail high financial risks.

An intent for buying a new item, for instance, is a typical function of traditional recommender systems. Commonly, a customer is provided with options from a menu of items to express his or her intent. However in reality, an intent may not be very specific because similar intents can replace the original intent. For example, a system may recommend buying a pre-used item or renting the item, aside from recommending buying a new item. Moreover, an intent may be substantiated with additional background information, and thus related indirect intents can be discovered. For example, a customer in a bank may have expressed an intent to exchange foreign currency. In this case, a banking service rendered is ordinarily currency exchange. However, assuming that additional information is provided that mentions about the customer staying in a destination country and that the customer has a bank account based in that country, a different service may be recommended to the customer. For example, remitting the money and withdrawing it in the destination country since it gives higher rate. The above scenarios can be handled effectively if there is a technology that is capable of interpreting indirect intents aside from directly-expressed intents.

Traditional recommender systems are designed to offer a specific service or a set of services. Several recommender systems may be integrated to handle multiple intents. This can be a straightforward solution. Still it requires a customer to enumerate all the intents, which may not be practical at all. A better solution is a system that can highlight or remind a customer of the related intents aside from his or her direct intent. Moreover, for multiple intents, a common assumption is that all intents are mutually exclusive from each other. However, considering multiple intents that can be direct and indirect, and that some recommendation can be a replacement of other recommendations, it may be desirable to have a recommender system that can handle multiple intents, direct or indirect.

Most traditional systems provide recommendations with minimal risk, if not without risk. Typically, the transactions in these systems involve fixed price for an item or a service. However, in few practical cases, a recommendation may not be indicated with fixed price, especially in cases that have to consider financial transactions, changing currency rates, commodity and service cost fluctuations, among other financial parameters, as an essential component for providing a recommendation. Therefore, a recommender system that incorporates risk evaluation may be desirable.

Therefore, for a customer who expresses an intent with a background information related to that intent, or for another customer who expresses multiple intents, traditional recommender systems may not be capable to provide additional recommendations that are related to an intent as well as coherent recommendations based on multiple intents. Further, traditional recommender systems may not be able to provide recommendations based on multiple intents that are easy to use, and provide risk metrics as a key factor for choosing a recommendation.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a system for interpreting intents and providing recommendations based on the intents is provided. The system may include a multiple-intent interpreter configured to receive a customer expression and interprets a plurality of intents from the expression. The plurality of intents may include two or more specific intents, or at least one specific intent and one general intent, or at least one specific intent and a background information. The plurality of intents may be processed by the system to discover other related intents from an intent network. The intent network may be generated by analyzing a body of literature from Internet sites, and finding the correlations between intents. In searching the intent network to discover related intents, the intents may be grouped into intent sets, where each intent set may correspond to one recommendation. The system may further include a recommender that provides a set of recommendations based on a set or sets of intents. Each recommendation may be evaluated with a risk index that is calculated based on news reports, financial data, blogs, and opinion write-ups, which may be available from public domain as well from private domain.

In an aspect of the disclosure, a method for interpreting intents and providing recommendations based on the intents is provided. The method may include receiving a customer expression and interpreting a plurality of intents from the expression. The plurality of intents may include at least two specific intents, or at least one specific intent and one general intent, or at least one specific intent and a background information. The plurality of intents may be processed to discover other related intents from an intent network. The intent network may be generated by analyzing a body of literature from Internet sites, and finding the correlations between intents. In searching the intent network to discover related intents, the intents may be grouped into intent sets, where each intent set may correspond to one recommendation. The method may further include providing a set of recommendations based on a set or sets of intents. Each recommendation may be evaluated with a risk index that is calculated based on news reports, financial data, blogs and opinion write-ups, which may be available from public domain as well from private domain.

In an aspect of the disclosure, a method, a computer-readable medium, and an apparatus for a recommendation system are provided. The apparatus may receive an expression. The apparatus may extract a set of intents from the expression. The apparatus may derive a plurality of intents based on an intent network and the set of intents. Each node of the intent network may represent an intent; and each edge of the intent network may represent a correlation between two intents corresponding to two nodes of the edge. The apparatus may make recommendations for the plurality of intents.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows a conceptual diagram of a system consisting of a multiple intent interpreter and a recommender.

FIG. 2 shows an example of a system flow diagram of the system described above in FIG. 1.

FIG. 3 shows a diagram of current banking service.

FIG. 4 is a diagram illustrating an example of the banking service that may be conducted in one embodiment of the disclosure.

FIG. 5 is a block diagram illustrating an example of a system for providing recommendations based on multiple intents.

FIG. 6 is a block diagram illustrating an example of a multiple intent interpreter.

FIG. 7 is a diagram illustrating an example of a user expression and an example of an expression template database.

FIG. 8 is a diagram illustrating an example of an intent database.

FIG. 9 shows a sample data for a first intent and a second intent, which may be derived from the intent database described above in FIG. 8.

FIG. 10 shows a flow diagram of a method for calculating weight values of the edges between intent nodes in an intent network.

FIG. 11 shows an example intent network.

FIG. 12 is a diagram illustrating an example of a banking process flow for remittance.

FIG. 13 is a block diagram of an example of a recommender.

FIG. 14 is a flow diagram of a method of recommendation selection.

FIG. 15 shows a diagram of a decision chart.

FIG. 16 is a block diagram of risk evaluation that quantifies the risk of recommendation cases and prioritizes them from least to high risks.

FIG. 17 shows an example user and output interface.

FIG. 18 is a flowchart of a method for a recommendation system.

FIG. 19 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a recommender system will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media may include a random-access memory (RAM), a read-only memory (ROM), an electrically erasable programmable ROM (EEPROM), a flash memory, optical disk storage, magnetic disk storage, other magnetic storage devices, combinations of the aforementioned types of computer-readable media, or any other medium that can be used to store computer executable code in the form of instructions or data structures that can be accessed by a computer.

A traditional recommender system deals with a single intent to provide a recommendation, and the transaction involved in the recommendation entails minimal risk. In one embodiment of the present disclosure, an intent interpreter that aims to explore multiple intents and a recommender system that provides recommendations with risk evaluation are provided. The concept of multiple intents may stem from a system that is able to recognize a background information in a way that the recommendation can be a deviation from the expected recommendation, or that the recommendation can be a combination of the expected recommendation and other recommendations.

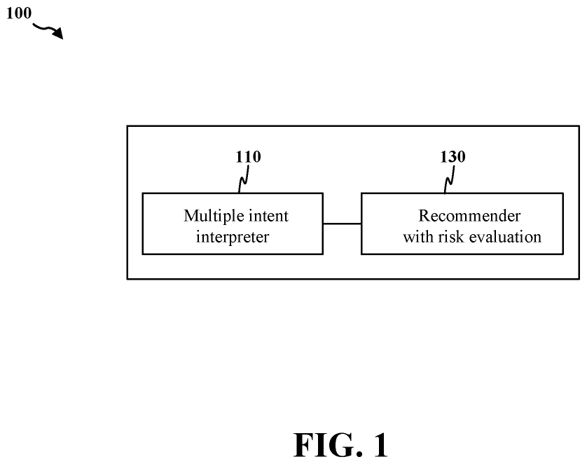

FIG. 1 shows a conceptual diagram of a system 100 consisting of a multiple intent interpreter 110 and a recommender 130. The system 100 may provide recommendations based on the perceived multiple intents of a customer.

According to various embodiments, the system 100 may include the multiple intent interpreter 110 configured to receive a customer expression and interprets a plurality of intents from the expression. The plurality of intents may include at least two specific intents, or at least one specific intent and one general intent, or at least one specific intent and a background information. The plurality of intents may then be processed by the system 100 to discover other related intents from an intent network. The intent network may be generated by analyzing a body of literature from Internet sites, and finding the correlations between intents. In searching the intent network to discover related intents, the intents may be grouped into sets, where each intent set may correspond to one recommendation.

The system 100 may further include the recommender 130 that receives a set or sets of intents and determine the recommendations with an associated risk index. A said recommendation may be evaluated with a risk index that is calculated based on news reports, financial data, blogs and opinion write-ups, which may be available from public domain as well as from private domain (e.g., financial domain).

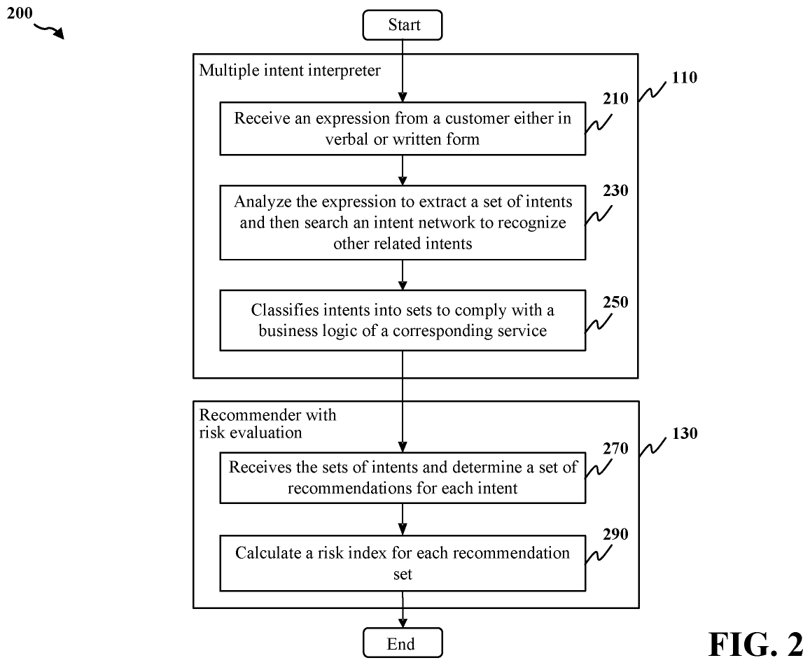

FIG. 2 shows an example of a system flow diagram 200 of the system 100 described above in FIG. 1. The system flow diagram 200 may be divided into two stages, which is that of the functions of the multiple intent Interpreter 110 and the recommender 130 with risk evaluation. As shown in the figure, the system may receive (at 210) an expression from a customer that is in at least one of verbal or written form, depending on the functions supported by the system. Subsequently, the system may analyze (at 230) the expression to extract a set of intents. In extracting intents from a customer expression, the system may be configured such that it may ask a customer a specific intent and a general intent, or a specific intent and background information, or a set of specific intents. Moreover, the system may be configured to confirm the extracted intents with the customer. The system may then proceed to search (at 230) an intent network to recognize other related intents. The system may then classify (at 250) intents into sets. One of the classification parameters may be that a set of intents comply with a business logic of a corresponding service provided by a business entity of the intended domain. For example, if the service is related to banking, the business logic may be the bank requirements for a customer. If a set of intents comply with the requirements, the set of intents may have a corresponding recommendation.

The system may receive (at 270) the sets of intents, and determine a set of recommendations for each set of intents. In particular, the recommender 130 may provide the recommendation from a plurality of same recommendation service providers, or may select the recommendation service provider from service providers. The recommender 130 may firstly search for past recommendation cases that are similar. If matches are found, the recommender 130 may recalculate the cost of recommendation if needed due to fluctuation in rates, among others. Then, the recommender 130 may proceed to create new recommendation cases by providing recommendations with a cost that may be comparable to past recommendation cases.

Finally, the system may calculate (at 290) a risk index for each recommendation set. It may evaluate the various risks that may affect the recommendations based on financial risk data sources. These financial risk data sources may come from public information, may be quantitative and non-quantitative data, such as exchange rates, interest, stock prices, currency rates, opinion, blogs and news.

In the above discussion about the system flow diagram 200, the search space in finding related intents from the intent network may be large, thus it may require enormous computational resources. As a result, the response time of the system from receiving a user expression to displaying a recommendation result may be long. One way to avoid or reduce the long response time may be to limit the search space. At 250, the system may check already the set of intents vis-à-vis the available recommendations. In that, the search space in the intent network would not be too large or conversely, the search time may be shortened.

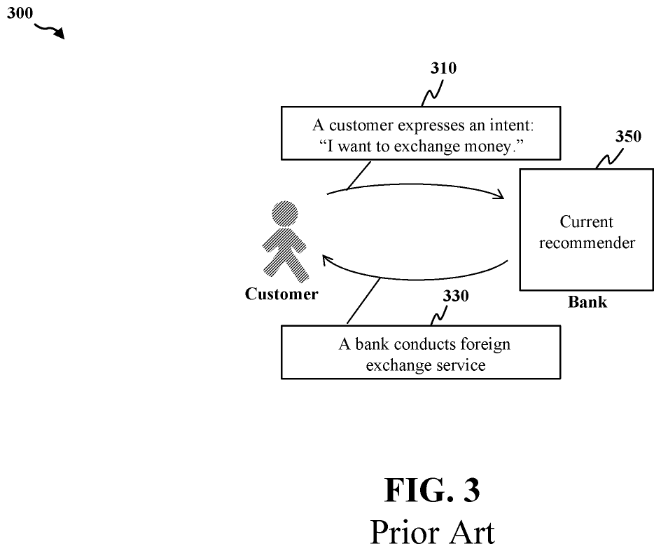

FIG. 3 shows a diagram 300 of current banking service. As depicted in the figure, it is assumed that current recommender 350 refers to a bank providing recommendation services to interested customers. A customer may express (at 310), “I want to exchange money.” to declare his intent of exchanging foreign currency. This example of intent is said to be specific since the customer's articulation refers to a particular service offered by a bank. Therefore, the bank as expected responds by providing (at 330) a foreign currency exchange service. Similar situation can also happen when another customer asks for other services.

As depicted in FIG. 3, a customer assistant in a bank has to handle the various queries or intents from customers. The intents can be about typical banking service within a bank branch, and complex services involving inter-bank branches as well as other financial institutions. While it is clear that the foremost objective is to fulfil the customer's intent, it may be recognized that a customer can be afforded with better services by providing options of the same effect to his original intent, aside from reward such as better rates, and discount. Alternatively, a customer may be provided with other services that complement to his original intent. These service-enhancing capability is difficult because it requires knowledge and skill to provide options and recommendations, to verify diverse information from banking-domain to public-domain to support recommendation proposal, to identify and contact entities who have to be involved as part of the recommendation as it may require inter-bank personnel from other institution.

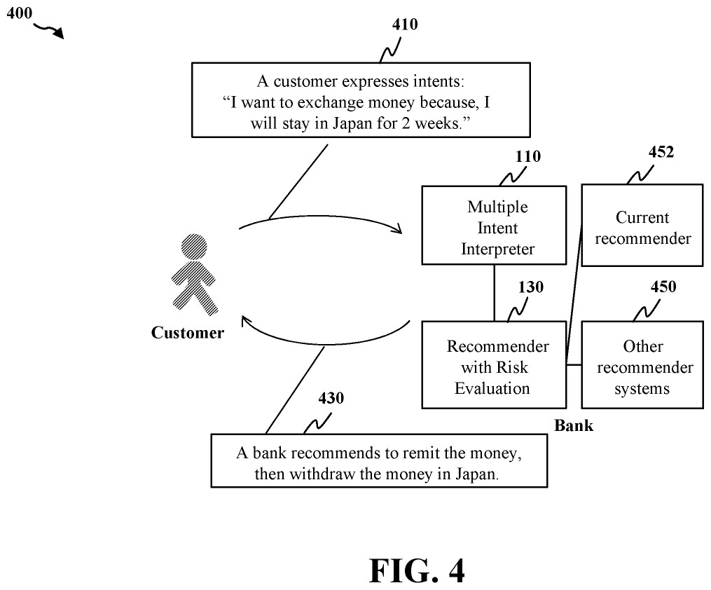

FIG. 4 is a diagram 400 illustrating an example of the banking service that may be conducted in one embodiment of the disclosure. The service can be realized by employing the multiple intent interpreter 110 and the recommender 130 with risk evaluation. Other recommender systems 450 may be integrated to a current recommender 452 to enhance the service offering of a bank. In one embodiment, the current recommender 452 may be the current recommender 350 described above with reference to FIG. 3.

As can be seen in the FIG. 4, the user expression 410 mentions a specific intent pointing to a particular banking service, which is the same as that of FIG. 3. In contrast, a general intent or background information is added. The phrase “I want to change money” is a specific intent that refers to a foreign exchange service. Moreover, the succeeding phrase “because I will stay in Japan for 2 weeks” gives an added information. For example, that the money will be spent for staying in Japan. This added information does not correspond to a specific banking service, although provides further awareness of the situation.

For one, the added information may be interpreted that the transaction for currency exchange may not be completed urgently. Therefore, one possibility is that instead of exchanging the currency based on the current rate. The money can be remitted at a later time with a projection that the exchange rate can be better at a later date, and that the money can be withdrawn in Japan, as described in 430. There are other possibilities such as recommending a credit card that currently offer an attractive promotional rate, among others.

Moreover, the added information means that a customer will obviously travel and thus needs travel-related services. For example, recommendations may be about travel insurance, hotel accommodation that is close to both the bank and meeting place, visa processing, ticket purchase, car-rental and other concierge services. As can be noticed, the services that can be offered may not only cover banking services but also other recommendation services. This enhancement of services can be realized by integrating current recommender 452 and other recommender systems 450.

Although FIG. 4 mentions only about foreign exchange, the specific intents related to banking may include but is not limited to services such as cancellation of credit cards, application for personal loans, transfer of deposit accounts, account opening, among others.

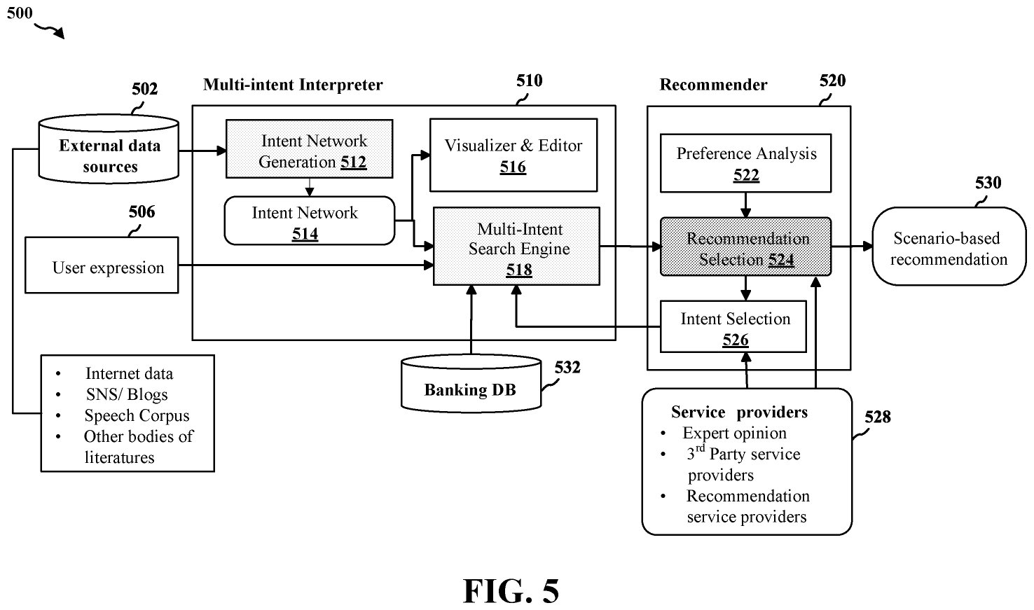

FIG. 5 is a block diagram illustrating an example of a system 500 for providing recommendations based on multiple intents. In the example, the system 500 may include a multi-intent interpreter 510 and a recommender 520. The multi-intent interpreter 510 may be configured to discover multiple intents from user expressions 506, either directly or indirectly. The recommender 520 may be configured to create a scenario-based recommendation 530 from the multiple intents discovered by the multi-intent interpreter 510. In one embodiment, the multi-intent interpreter 510 may be the multiple intent interpreter 110 described above, and the recommender 520 may be the recommender 130 with risk evaluation described above.

The multi-intent interpreter 510 may generate (at 512) an intent network 514 by searching external data sources 502. The external data sources 502 may include one or more of internet data, social networking service (SNS), blogs, speech corpus, or other bodies of literatures. In one embodiment, the intent network 514 may be generated by evaluating the relation between intents based on the frequency of occurrence of intents on same or similar external source.

The multi-intent interpreter 510 may include a visualizer and editor 516 and a multi-intent search engine 518. The visualizer and editor 516 may be configured to visually present the intent network 514 and enable editing of the intent network 514 (e.g., through a graphical user interface). The multi-intent search engine 518 may be configured to search for an intent and other intents in the intent network 514 based on the user expression 506. In one embodiment, the multi-intent search engine 518 may select a group of intents based on direct connections from an intent (cluster) and based on the path between two intents. In one embodiment, the multi-intent search engine 518 may search and select intents based on a banking database 532.

The recommender 520 may analyse (at 522) the preference of the user. The recommender 520 may select (at 524) recommendations for multiple intents. The recommendations may be provided by service providers 528, which may include one or more of domain experts, third party service providers, or recommendation service providers. In one embodiment, the recommender 520 may select (at 526) intent based on input from the service providers 528 and the recommendation selection at 524. The selected intent may be fed back to the multi-intent search engine 518 for further search within the intent network 514.

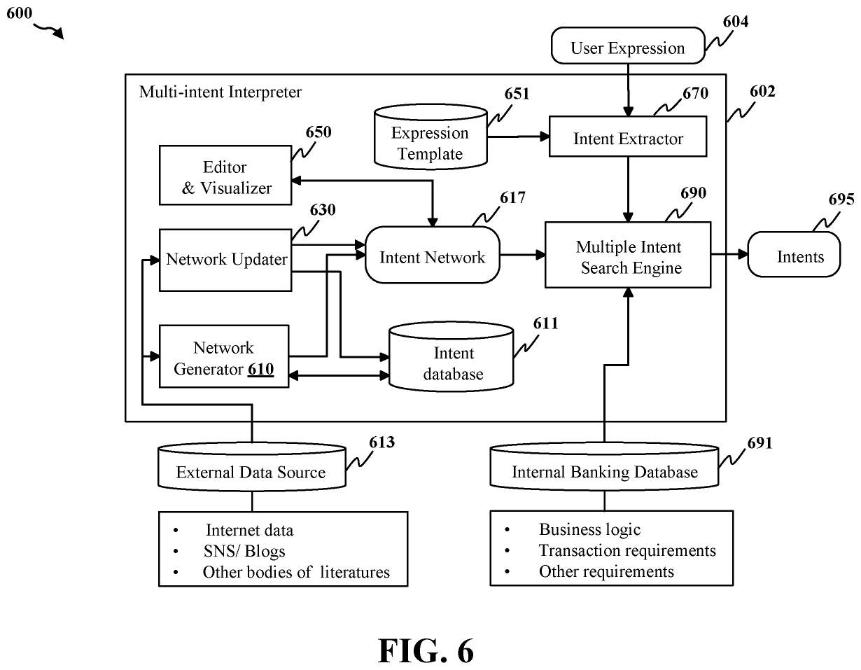

FIG. 6 is a block diagram 600 illustrating an example of a multiple intent interpreter 602. In one embodiment, the multiple intent interpreter 602 may be the multiple intent interpreter 110 or the multi-intent interpreter 510 described above. The multiple intent interpreter 602 may include a network generator 610. The network generator 610 may initially create an intent network 617 by utilizing intent database 611 and external data source 613. The intent database 611 may contain initial intents and the rules (e.g., search patterns) to search the external data source 613, as well as to update the intent network 617 by network updater 630.

In one embodiment, the intent network 617 may be a tree or graph-like structures of nodes and edges with multiple weights. Each node of the intent network 617 may represent an intent that has intent elements. Each edge of the intent network 617 may represent a correlation between two intents corresponding to two nodes of the edge. A weight of an edge may represents the degree of correlation between two intents corresponding to two nodes of the edge.

In one embodiment, the network generator 610 may employ text analysis to search for the existence of intents and conduct statistical analysis to find correlation between intents such as their occurrence in the same or similar source. The text analysis may be conducted at various sentence levels such as word-level, clause-level, among others. The text analysis may be conducted by a combination of the following analyses such as part of speech tagging, semantic analysis, syntax analysis, parsing, among others.

In the intent database 611, the initial list of intents may be prepared by taking into account that an intent has a corresponding recommendation to cater it. Each element of the intent database 611 may include a set of pre-defined search patterns that can be associated with an intent. For example, if the intent is “Deposit Cash”, the search patterns may be “Want to deposit money”, “Put cash in bank”, “Cash-at-hand for deposit”. Further, these search patterns may be automatically generated through an automated pattern generation method. Other details in the intent database 611 may be added such as location, previously associated background information, update time, among others.

The external data source 613 may include but is not limited to data that is publicly searchable in the Internet, blog sites, data from social networking sites, online books and other bodies of digital literatures. In the case of Internet sites and blog sites, a crawling function may be utilized to discover other websites based on their links.

In one embodiment, the network updater 630 may conduct the update process for the intent network 617 and the content of intent database 611. In one embodiment, editor and visualizer 650 may be used by an authorized user to edit and visualize the intent network 617.

The multiple intent interpreter 602 may include an intent extractor 670 and a multiple intent search engine 690. The intent extractor 670 may process user expression 604 to extract an intent. In one embodiment, the intent extractor 670 may use an expression template database 651 to extract the intent. The multiple intent search engine 690 may search for an intent and other intents in the intent network 617 based on the intent extracted by the intent extractor 670, and output a set or sets of intents 695. In one embodiment, the multiple intent search engine 690 may select a group of intents based on direct connections from an intent (cluster) and based on the path between two intents in the intent network 617. In one embodiment, the multiple intent search engine 690 may classify intents into intent sets using an internal banking database 691. In one embodiment, the internal banking database 691 may include one or more of business logic, transaction requirements, or other requirements.

An intent expressing an access to a particular banking service may be referred to as a specific intent. If a specific intent (e.g., “I need to exchange money”) with a background information (e.g., “I will stay in Japan”) is taken into consideration, the number of options to access other banking services may be increased.

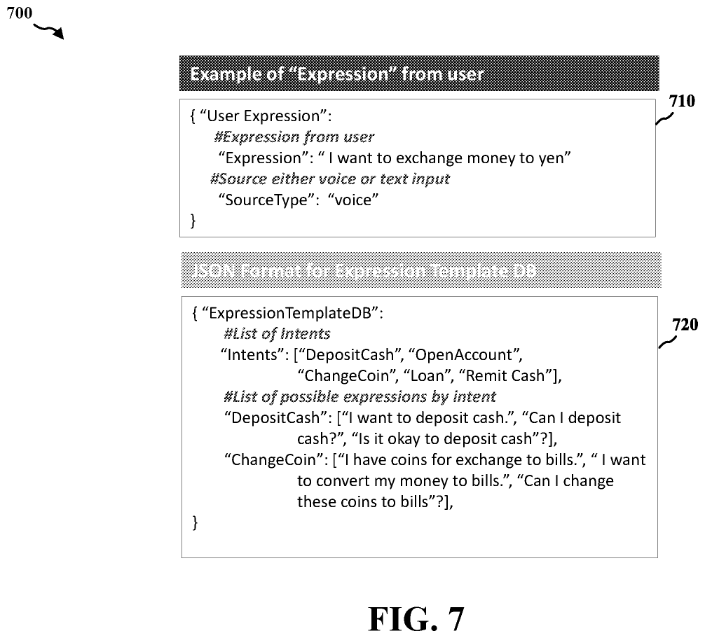

A user expression (e.g., the user expression 604) may be uttered by a customer or can be written through text. An expression template database (e.g., the expression template database 651) stores the possible expressions that may be associated to an intent. FIG. 7 is a diagram 700 illustrating an example of a user expression 710 and an example of an expression template database 720. As illustrated, the expression template database 720 may include a list of intents and a list of possible expressions for an intent.

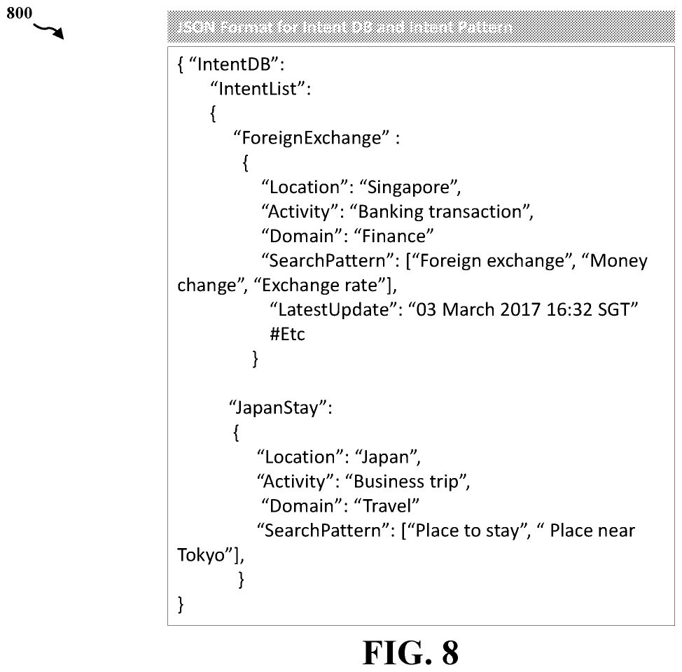

FIG. 8 is a diagram illustrating an example of an intent database 800. As illustrated, the intent database 800 may include a list of intents that are checked to be having respective recommendation or a set of recommendations. Each intent in the intent list has a set of pre-defined search patterns. For example, if the intent is “Deposit Cash”, the search patterns may be “Want to deposit money”, “Put cash in bank”, “Cash-at-hand for deposit”. In another example, if the intent is “Foreign Exchange”, the search patterns may be ““Foreign exchange”, “Money change”, “Exchange rate”. In one embodiment, these search patterns may be automatically generated. Other details associated with an intent may be location, previously associated background information, update time, among others.

Traditionally, on the basis of user interface, intents are expressed in a limited manner through menu options, check boxes, among others. In reality, however, an intent may not be very specific because similar intents can replace the original intent. Moreover, an intent may be substantiated with additional background information. Based on this observation, a system may need to be able to allow user the flexibility to express intent, e.g., through verbal or written form. In the case of verbal form, an automatic speech recognition unit may be utilized to translate spoken words to text form. At that stage, the processing may be similar to a written-form user expression. Consequently, a natural language processing unit may be utilized to process user expression and extract the intent. Subsequently, the system may need to discover indirect intents aside from handing directly-expressed intents.

The discovery of intents in the intent network may rely on how the intent network is created and may be determined by several factors such as the source of intent data, the type of data source, the search pattern and method, among others. Initially, the intent network may need to be populated with intent nodes or to create intent nodes that will comprise the intent network. One method is to consider two input intents and utilizes the intent details such as to create possible search patterns.

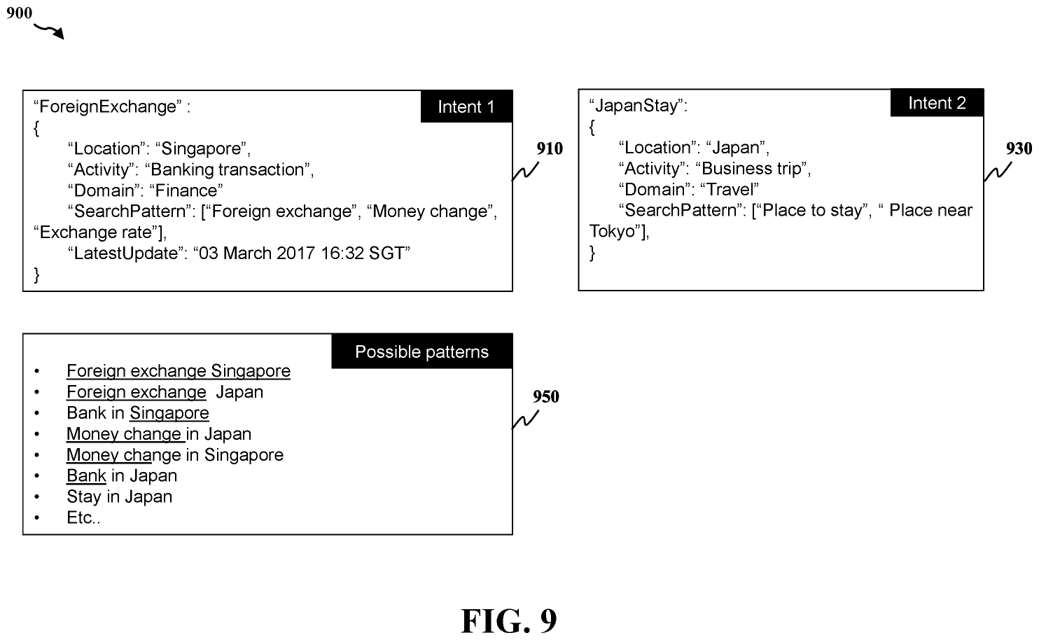

FIG. 9 shows a sample data for a first intent 910 and a second intent 930, which may be derived from the intent database 800 described above in FIG. 8. Based on user expression, other details may be referenced such as location, activity, domain and search patterns. Take the intent 910 as an example. The location may be implicitly determined and the location granularity may be finer such as by GPS location or by an exact address of a bank. The activity field is a general classifier to specify that the intent 910 is about a banking transaction, while the domain field is a wider classifier that encompasses banking operations. The search patterns are the parameters to be used in searching a data source for the existence of the corresponding intent. The details of intents 910 and 930 may be combined to create search patterns as shown in 950. Note that the underlined parts of the search patterns 950 come from intent 910 details while those that are not underlined are from intent 930 details. The above method may be undertaken with an assumption that a specific activity in an origin country may be similarly done in the destination country so that location and activity are tried as search pattern in search patterns 950. In essence, the search patterns 950 may be made depending on the context of the intents involved. The search patterns 950 may be used to discover intents that are related to the intents 910 and 930.

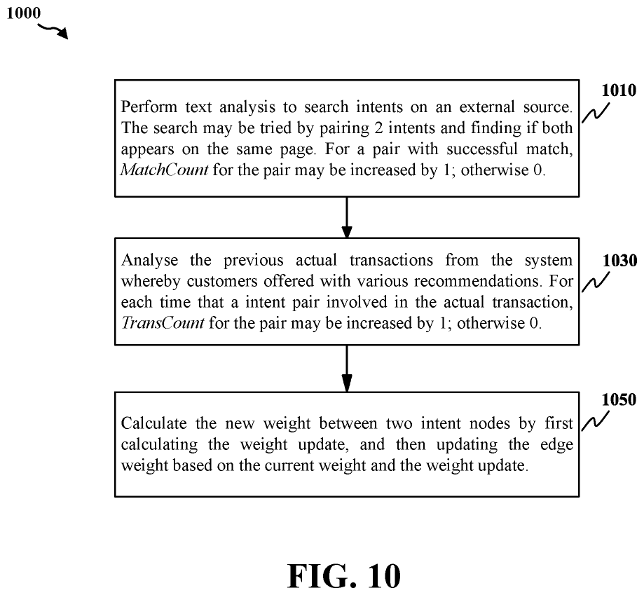

FIG. 10 shows a flow diagram 1000 of a method for calculating weight values of the edges between intent nodes in an intent network. In one embodiment, after generating the intent nodes of the intent network, the weight of an edge connecting two intents is calculated. In one embodiment, the method may be performed by a network generator (e.g., the network generator 610).

At 1010, the method may performs text analysis to search intents on an external source. The search may be tried by pairing two intents and finding if both appears on the same page within the external source. For a pair with successful match, MatchCount for the pair may be increased by 1; otherwise 0.

At 1030, the method may analyze the previous actual transactions from the system whereby customers offered with various recommendations and that the recommendation is successfully accepted. For each time that a pair of intents are involved in the actual transaction, TransCount for the pair may be increased by 1; otherwise 0.

After considering the data from external source and the system historical data, the method may calculate (at 1050) the new weight between two intent nodes by first calculating the weight update, and then update the edge weight based on the current weight and the weight update.

Suppose w(Initent1, Intent2) denotes the edge weight between Intent1 and Intent2, and w update denotes the update value for the edge weight. Initially, the weight is equivalent to zero and is updated by equation (1) and equation (2) below. The weight update may be expressed as:

W_{update}=α_{externalSearch}*MatchCount+α_{actualTrans}*TransCount (1)

Where:
α_{externalSearch} is an update factor for external data search;
α_{actualTrans} is an update factor for actual transaction;
MatchCount is the number of matches in the text analysis for Intent1 and Intent2; and
TransCount is the number of actual transactions involving Intent1 and Intent2.

The values of update depends on the significance of the result of external data search over the result of actual transaction or vice versa. In measuring the number of matches in the text analysis and the actual transaction, a tracker may be needed to ensure that previous searches and measurements are not repeated.

After calculating the value of weight update, the edge weight may be calculated by,

w(Intent1,Intent2)=m*w_{current}+(1−m)*w_{update} (2)

Where:
m is a memory factor to retain only a fraction of old info and replace with new info;
w_{current} is the current weight value; and
w_{update} is the calculated update weight.

The memory factor m may be determined based on the significance of recent update over the previous weight values. The weight calculation may be unimportant in some cases as some intents are pairs by default as part of service. For example, the weight calculation may be unimportant for the edge between remittance and accept remittance, since these two intents are basic functions for inter-bank remittance.

After populating the intent network with intent nodes and calculating the edge weights, the network generation is said to be completed. At this stage, the interpreter (e.g., the multiple intent interpreter 602) may be ready to receive a user expression (e.g., the user expression 604), which is then processed by the intent extractor (e.g., the intent extractor 670) to extract an intent or a set of intents. The expression template database (e.g., the expression template database 651) may include a list of possible variations in expressing an intent, and/or a list of rules to extract keywords that can be associated to an intent. The expression template database may also be a natural language unit that is capable of differentiating and detecting variations of an intent. The searching for related intents, e.g., by the multiple intent search engine 690, may proceed next.

The intent network (e.g., the intent network 617), which is initially created and updated, may then be searched by the multiple intent search engine (e.g., the multiple intent search engine 690). In one embodiment, the search is not initiated from finding a list of recommendations, but is invoked at finding first a list or set of intents that will form the basis for creating a list of recommendations. This is the function of the multiple intent search engine, whereby the end result provides recommendations that can be a replacement of the as-expected recommendation. Moreover, the multiple intent search engine may be capable of discovering intents that are found to be highly correlated to an intent. One advantage of having this is that, a system can highlight or remind a customer of the related intents aside from his intent that is directly expressed.

Based on the foregoing discussion, the multiple intent search engine may utilize the intents extracted from user expression to search for other intents in the intent network and selects a set of intents based on the connections from the intent extracted from the user expression. For at least two intents that are extracted, an intent may be selected based on the connecting paths between these at least two intents. The selection of the set of intents is also determined by considering an internal banking database (e.g., the internal banking database 691).

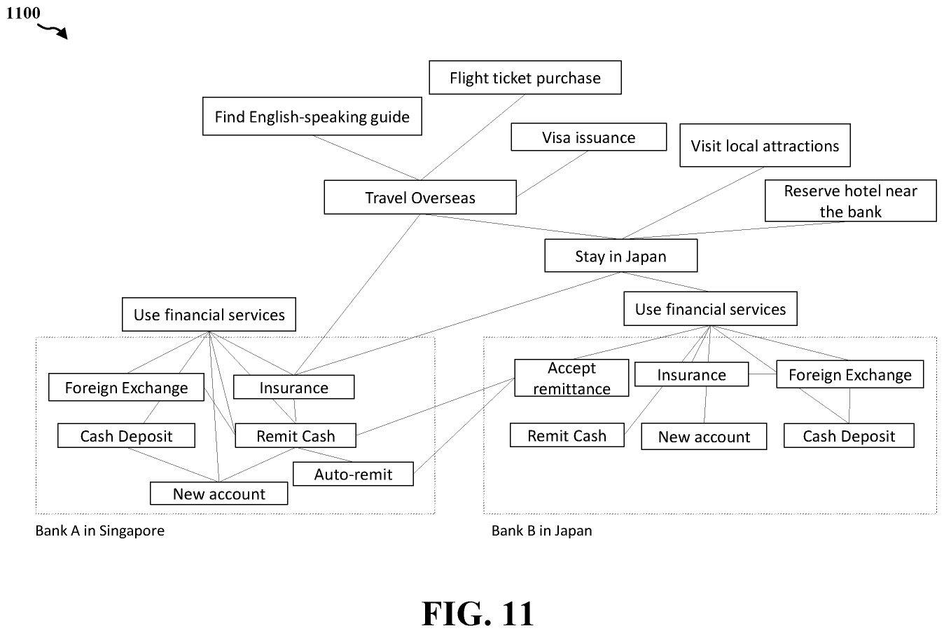

FIG. 11 shows an example intent network 1100. In one embodiment, the intent network 1100 may be the intent network 514 or 617 described above. In one embodiment, the intent network 1100 may be a tree or graph network of nodes and weighted edges. Each node may represent an intent and a weight may represent a relational value of two connected intents. For intents inside a bank, it may not require searching external source to create their nodes and connections since the basis for these intents is the banking services of the bank. Moreover, some nodes may be regarded as link hub that links only related nodes to other nodes. For example “use financial services” and “stay in Japan” in the intent network 1100 are shown as intent nodes. However, they only represent as links to connect to real intent nodes. In this case, these nodes will not appear as a part of an intent set. Normally, these types of nodes are created based on the user expression which is recognized as background information.

In one embodiment, an internal banking database (e.g., the internal banking database 532 or 691) may be used to check if the sets of intents can be consistent with the banking process flow requirements, constraint, among others. For example, if the set of intents result in inter-bank transaction across borders, a customer may be required for identification and bank account information of the two transacting banks. The internal banking database may also contain historical and current financial rates such as various types of exchange rate, interest rates, and commissions, among others.

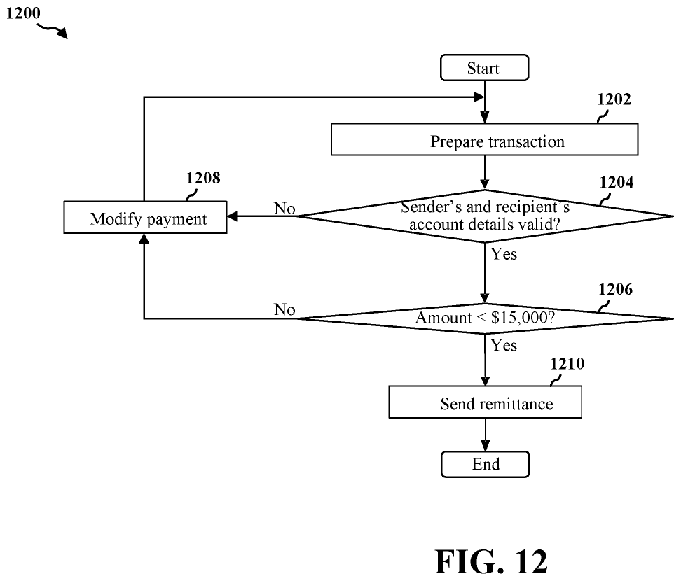

FIG. 12 is a diagram illustrating an example of a banking process flow 1200 for remittance. In one embodiment, the banking process flow 1200 is the practiced procedure or method that may need to be taken into consideration when selecting intent nodes. For example, the procedure may indicate that a bank account information are required for sender and recipient. Further, it may imply that the bank accounts of the sender's bank and recipient's banks are transacting banks.

At 1202, the method may prepare to perform the transaction. At 1204, the method may determine whether the sender's account details and the recipient's account details are valid. If the account details of the sender and recipient are valid, the method may proceed to 1206. Otherwise, the method may proceed to 1208.

At 1206, the method may determine whether the amount involved in the transaction is less than $15,000. If the amount involved is less than $15,000, the method may proceed to 1210. Otherwise, the method may proceed to 1208.

At 1208, the method may modify payment (e.g., modifying sender or recipient's account details, or modifying amount) to comply with the restrictions. The method may then loops back to 1202. At 1210, the method may send remittance.

In one embodiment, an internal banking database (e.g., the internal banking database 532 or 691) may contain information that two or more banking transactions may have the same effect given a specific condition and hence, choosing either transactions is possible. For example, a transaction is foreign exchange for person going overseas, assuming that the currency will be spent at the destination country. An example of a transaction with the same effect as that of exchanging for foreign currency in the origin country is to remit cash in the origin country and then receive the remittance at the destination country. Since these banks are transacting, the corresponding intent nodes in the intent network can be expected to be connected.

As descripted above, the multiple intent search engine may search the intent network for the connection of intent nodes. Suppose there is only one single intent, it returns intents connected to the intent with high weight value. Note however, that the main purpose of this disclosure is to search for one specific intent and one background information. Therefore, for multiple intents, the multiple intent search engine returns intents connections with high weight values and the path between intents. Using the intent network 1100 described above in FIG. 11, the possible intent set may be:
{Foreign Exchange},
{Foreign Exchange, Buy Insurance, Reserve Hotel Near the Bank}
{Foreign Exchange, Buy Insurance},
{Remit Cash, Accept Remittance, Buy Insurance}
{Remit Cash, Accept Remittance, Buy Insurance, Reserve Hotel Near the Bank}

In the above intent sets, some nodes are not listed as part of an intent set because these nodes are regarded as link hub that links only related nodes. Examples of link hubs are “Use financial services”, and “Stay in Japan”.

Searching for the related multiple intents may be regarded as a travelling salesman problem, which is a complicated problem. It is a NP-hard problem (non-deterministic polynomial-time hard problem). There are several ways to tackle this problem, depending on the available computational resources. For example, using exact methods may require prohibitively long calculation time especially if the network is too large. For the problem at hand, it may be practical to use approximate methods like Lin-Kernighan method that is a type of variable λ-opt.

Most traditional systems provide recommendations with minimal risk, if not without risk. However, in few practical cases, a recommendation may not be indicated with certainty by indicating only a fixed price. Especially those involving financial transactions, changing currency rates, commodity and service cost fluctuations, among other financial parameters have to be considered as an essential component for providing a recommendation. Therefore, one embodiment of the system may be equipped with functionality to provide recommendations that incorporates risk evaluation. The above-mentioned possible intent sets may then be processed by recommender with risk evaluation (e.g., the recommender 130).

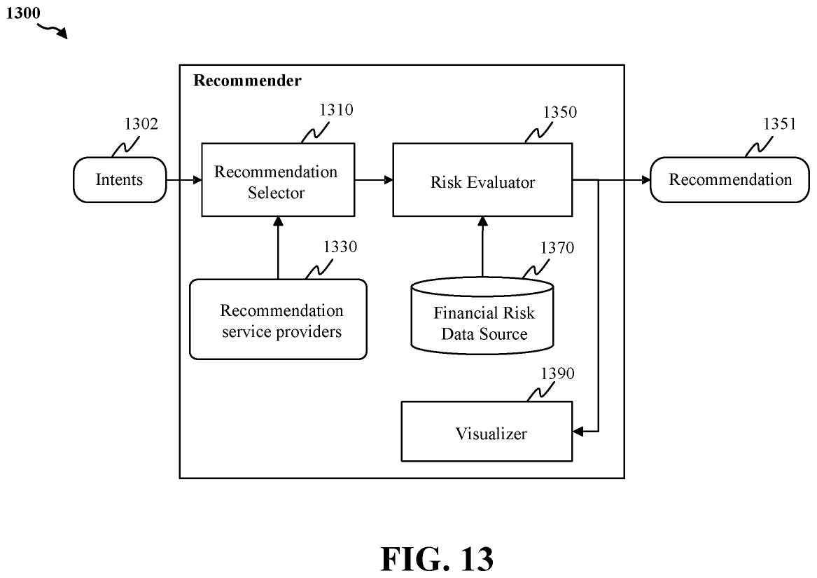

FIG. 13 is a block diagram of an example of a recommender 1300. In one embodiment, the recommender 1300 may be the recommender 130 or 520 described above. The recommender 1300 may provide recommendations from a set of multiple intents 1302. Recommendation selector 1310 may select the recommendation from a plurality of recommendations or select the recommendation service provider from recommendation service providers 1330. Recommendation selector 1310 may be applied to intents with several recommendation options that can be selected. Risk evaluator 1350 may evaluate the various risks that may affect the recommendations based on a financial risk data source 1370. Visualizer 1390 may provide the visualization of the intents 1302 and the recommendations 1351.

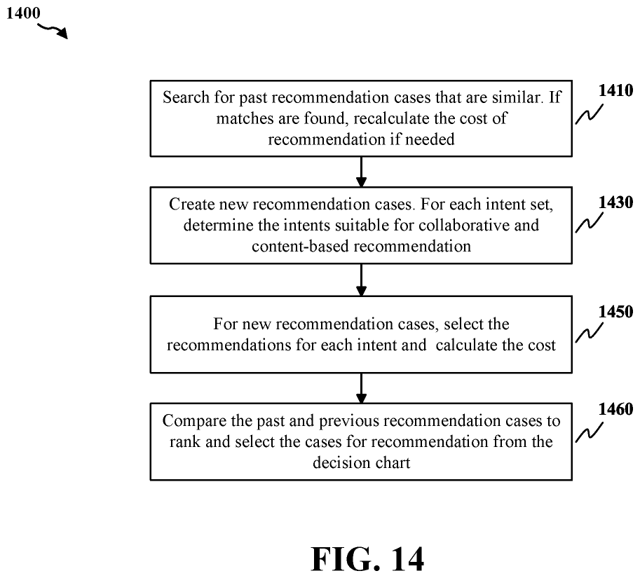

FIG. 14 is a flow diagram 1400 of a method of recommendation selection. In one embodiment, the method may correspond to the operations performed by recommendation selector 1310 described above with reference to FIG. 13. In one embodiment, a two-level recommendation may be made. The first level may correspond to an intent set which has similar past cases of recommendation, while the second level may correspond to searching for recommendation of each intent in the intent set, which is generally made if a new case of recommendation has to be conducted. For a given intent set, it may be a combination of several intents, thus requiring recommendation for each intent.

At 1410, the method may search for past recommendation cases that are similar. If matches are found, the method may recalculate the cost of recommendation if needed due to fluctuation in rates, among others.

In one embodiment, the recommendation may be a combination of collaborative and content-based recommendation. Collaborative recommendation recommends based on other user's rating which assumes that users with similar profiles may choose same product. Content-based recommendation offers products similar to a product being selected.

At 1430, the method may create new recommendation cases. For each intent set, the method may determine whether the intents are suitable for collaborative or content-based recommendation.

At 1450, for new recommendation cases, the method may select the recommendations for each intent and calculate the cost. The cost may be calculated based on the item sale price or the cost of a service. If it is a combination of a services and products, then a total of the services and products considering discounts.

At 1460, the method may compare the past and new recommendation cases to rank and select the cases for recommendations.

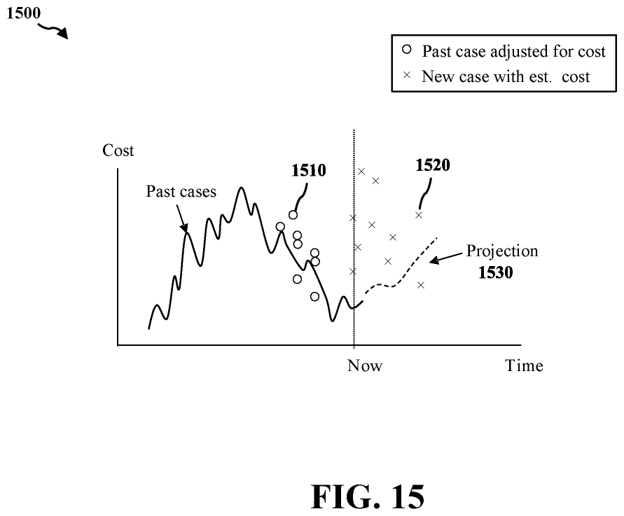

FIG. 15 shows a diagram of a decision chart 1500. The decision chart 1500 may be used to determine which recommendation case can be selected. The decision chart 1500 shows the cost of the past recommendation cases. The circle plots (e.g., 1510) show that past case adjusted for the current rate, among others. The “x” plots (e.g., 1520) show the new cases with the estimated cost. In selecting the recommendation cases in one embodiment, the case with cost that is close to current or projected line 1530 may be selected. In one embodiment, a few past cases that are estimated to lie on the projection line 1530 may be selected.

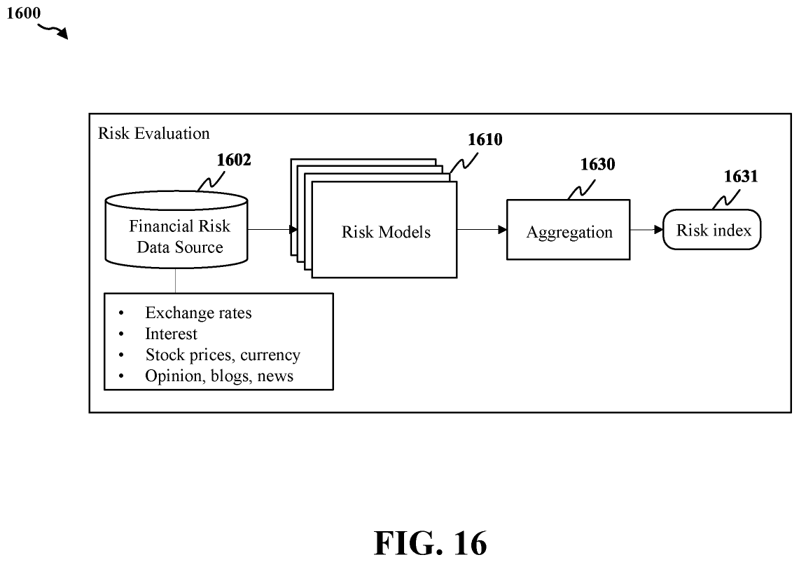

FIG. 16 is a block diagram of risk evaluation 1600 that quantifies the risk of recommendation cases and prioritizes them from least to high risks. In one embodiment, the risk evaluation 1600 may perform operations described above with regard to the risk evaluator 1350 in FIG. 13. In one embodiment, risk data source 1602 may come from public information which can be quantitative and non-quantitative data such as exchange rates, interest, stock prices, currency rates, opinion, blogs and news.

Various Risk Models 1610 may be utilized in implementing risk evaluation 1600, depending on the appropriate risk data input to calculate risk values. Examples of risk models are extreme value theory, historical simulation, Value at Risk, among others. Later these risk values are aggregated into one risk index. Aggregation 1630 may employ calculation of weight distribution for each risk values and summing weighted risk values into a risk index 1631, e.g., on a scale from 1 to 10.

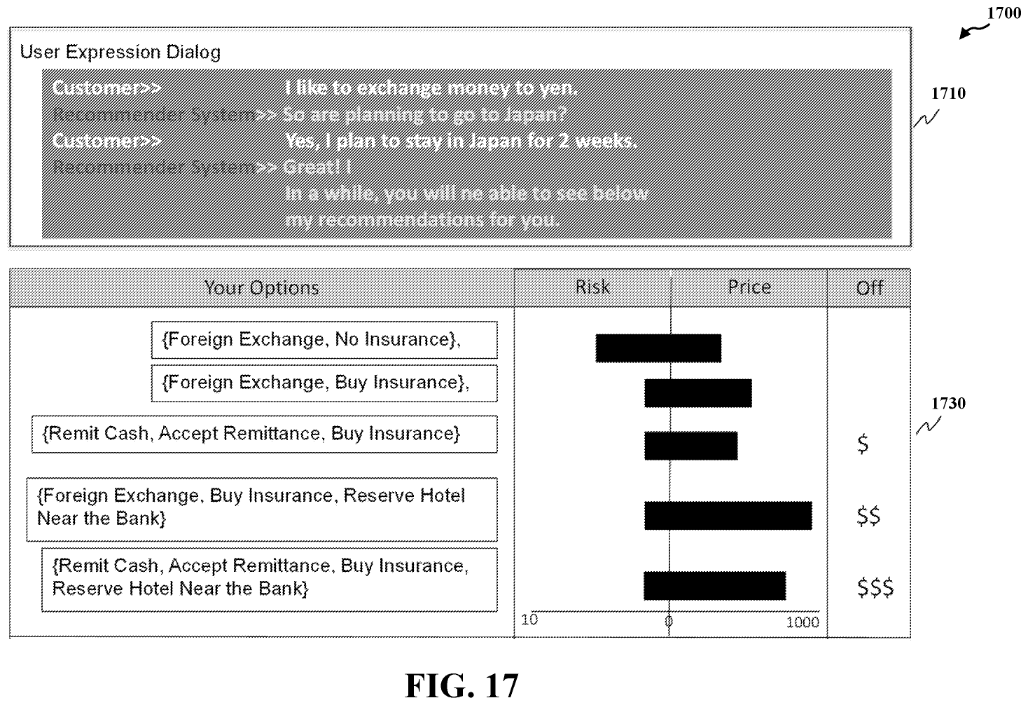

FIG. 17 shows an example user and output interface 1700. The user and output interface 1700 includes a user expression dialog 1710 and a recommendation result 1730. The user expression dialog 1710 may provide a chat-based interface where a user may enter an intent and the system may interactively communicate to the user. In some cases, the system may recognize that it has received at least two specific intents. In others cases, the system may ask the user to confirm the received intents.

In one example, the system may ask about a background information by recognizing past cases wherein a specific intent is highly correlated to a background information. After the system has recognized that it has already one specific intent and one background information, it may notify the user to wait for the recommendation results. The recommendation result 1730 may then show the five options based on the user expression, as well as the risk, price, and off savings associated with each option. The five options shown may be a result of the five intent sets found by a multiple intent interpreter (e.g., the multiple intent interpreter 110, 510, or 602). The evaluations shown denoting the risk, price, and off savings may be the result of the evaluation made by a recommender with Risk Evaluation (e.g., the recommender 130, 520, or 1300). Note that in the options provided, the services offered are enhanced from simply foreign exchange to a bundle of services consisting remittance, buying insurance and reserving hotel. This is the objective of this disclosure, which is to explore highly correlated intents that can be weaved to create coherent recommendation to be finally considered as a bundled services. For this reason, recommendation evaluation considering both price and financial risks may be a key feature in one embodiment of the disclosure.

In one embodiment, the system may be used by bank customers and finance advisors. It may optimize service offerings by the combination of multiple intent recognition, extending available recommendation from external resources and evaluation of risks in the recommendations.

In one embodiment, the system may assist bank customers by providing enhanced service options. With that, a customer may be reminded of the related intents aside from the directly expressed one. Moreover, it may become easy for the customer to get recommendations by not enumerating all intents since the system is capable of recognizing intents that are highly correlated.

For financial advisors, the system may shorten the turn-around time to respond to queries about recommendations. Instead of relying on the skill and knowledge of a human expert, the system may complement the work for providing recommendations. Creating a recommendation is a complex task as it requires diverse information from banking-domain to public-domain to support recommendation proposal, as well as resources to identify and contact entities as part of the recommendation.

The multiple intent interpreter and recommender may be extended to other domains especially in service-oriented industries. In one embodiment, the multiple intent interpreter may predict other intents, while the recommender may provide recommendations by accessing recommendation providing services and taking into consideration the financial risk associated.

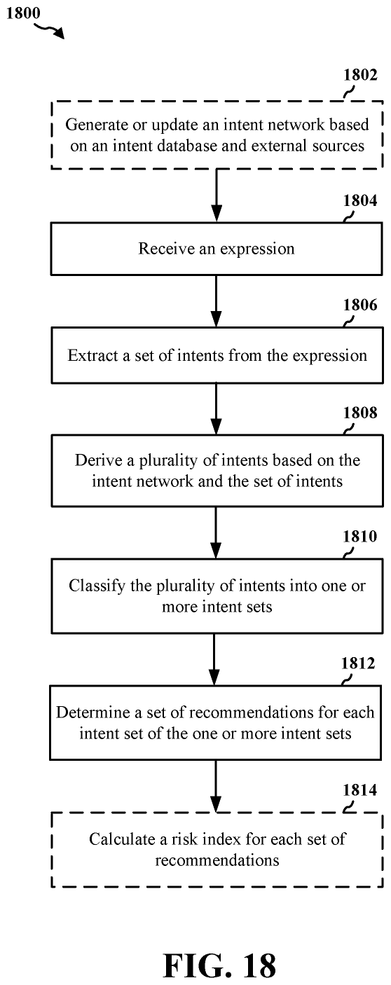

FIG. 18 is a flowchart 1800 of a method for a recommendation system. In one embodiment, the recommendation system may be the system 100 or 500 described above.

At 1802, the method may optionally generate or update an intent network based on an intent database and external sources. In one embodiment, each node of the intent network may represent an intent; each edge of the intent network may represent a correlation between two intents corresponding to two nodes of the edge. In one embodiment, the external sources may include at least one of Internet sites or digital literatures.

In one embodiment, to generate or update the intent network, the method may update the weight for an edge of the intent network. The weight may represent the degree of correlation between two intents corresponding to two nodes of the edge. In one embodiment, the weight may be calculated based on at least one of the frequency of the two intents on the same or similar external source or the frequency of the two intents involved in the same transaction.

At 1804, the method may receive an expression. The expression may be in verbal or written form.

At 1806, the method may extract a set of intents from the expression. In one embodiment, the set of intents may be extracted using one or more expression templates.

At 1808, the method may derive a plurality of intents based on the intent network and the set of intents. In one embodiment, the plurality of intents may include at least one of a set of direct intents or a set of indirect intents. In one embodiment, to derive the plurality of intents, the method may identify intents connected to the set of intents in the intent network with a correlation value that satisfies a threshold (e.g., greater than a threshold weight). In one embodiment, to derive the plurality of intents, the method may identify intents on the path between the set of intents in the intent network.

At 1810, the method may classify the plurality of intents into one or more intent sets. At 1812, the method may determine a set of recommendations for each intent set of the one or more intent sets. At 1814, the method may optionally calculate a risk index for each set of recommendations.

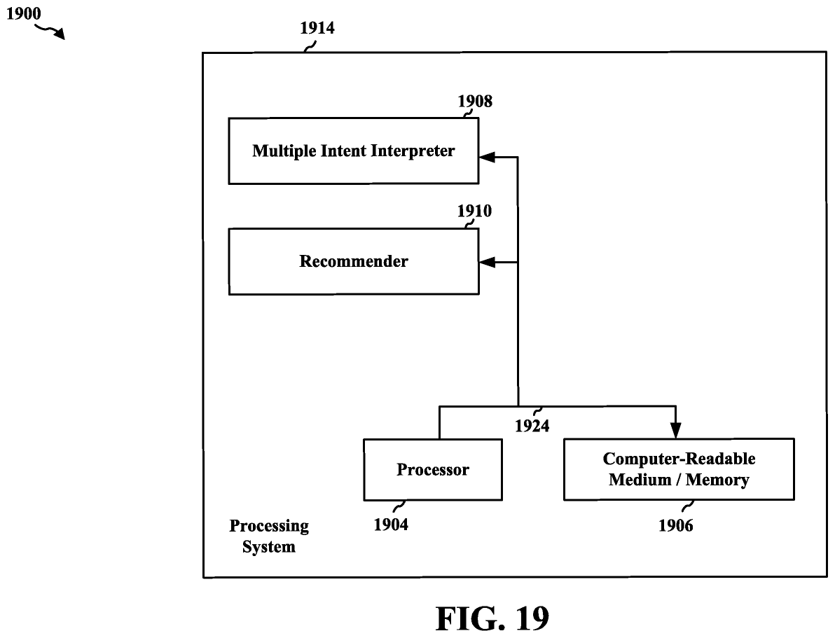

FIG. 19 is a diagram illustrating an example of a hardware implementation for an apparatus 1900 employing a processing system 1914. In one embodiment, the apparatus 1900 may implement the systems and methods described above in FIGS. 1-18. The processing system 1914 may be implemented with a bus architecture, represented generally by the bus 1924. The bus 1924 may include any number of interconnecting buses and bridges depending on the specific application of the processing system 1914 and the overall design constraints. The bus 1924 links together various circuits including one or more processors and/or hardware components, represented by the processor 1904, the components 1908, 1910, and the computer-readable medium/memory 1906. The bus 1924 may also link various other circuits such as timing sources, peripherals, voltage regulators, and power management circuits, which are well known in the art, and therefore, will not be described any further.

The processing system 1914 includes a processor 1904 coupled to a computer-readable medium/memory 1906. The processor 1904 is responsible for general processing, including the execution of software stored on the computer-readable medium/memory 1906. The software, when executed by the processor 1904, causes the processing system 1914 to perform the various functions described supra for any particular apparatus. The computer-readable medium/memory 1906 may also be used for storing data that is manipulated by the processor 1904 when executing software. The processing system 1914 further includes at least one of the components 1908, 1910. The components may be software components running in the processor 1904, resident/stored in the computer readable medium/memory 1906, one or more hardware components coupled to the processor 1904, or some combination thereof.

In one embodiment, the component 1908 may be the multiple intent interpreter 110, 510, or 602 described above. In one embodiment, the component 1910 may be the recommender 130, 520, or 1300 described above.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

In the following, various aspects of this disclosure will be illustrated:

Example 1 is a method or apparatus for a recommendation system. The method or apparatus may receive an expression, extract a set of intents from the expression, derive a plurality of intents based on an intent network and the set of intents, and make recommendations for the plurality of intents. Each node of the intent network may represent an intent. Each edge of the intent network may represent a correlation between two intents corresponding to two nodes of the edge.

In Example 2, the subject matter of Example 1 may optionally include that the method or apparatus may further classify the plurality of intents into one or more intent sets. To make recommendations, the method or apparatus may determine a set of recommendations for each intent set of the one or more intent sets.

In Example 3, the subject matter of Example 2 may optionally include that the method or apparatus may further calculate a risk index for each set of recommendations.

In Example 4, the subject matter of any one of Examples 1 to 3 may optionally include that the plurality of intents may include at least one of a set of direct intents or a set of indirect intents.

In Example 5, the subject matter of any one of Examples 1 to 4 may optionally include that the set of intents may be extracted using one or more expression templates.

In Example 6, the subject matter of any one of Examples 1 to 5 may optionally include that the method or apparatus may generate or update the intent network based on an intent database and external sources. The external sources may include at least one of Internet sites or digital literatures.

In Example 7, the subject matter of Example 6 may optionally include that, to generate or update the intent network, the method or apparatus may update the weight for an edge of the intent network. The weight may represent the degree of correlation between two intents corresponding to two nodes of the edge.

In Example 8, the subject matter of Example 7 may optionally include that the weight may be calculated based on at least one of the frequency of the two intents on the same or similar external source or the frequency of the two intents involved in the same transaction.

In Example 9, the subject matter of any one of Examples 1 to 8 may optionally include that, to derive the plurality of intents, the method or apparatus may identify intents connected to the set of intents in the intent network with a correlation value that satisfies a threshold.

In Example 10, the subject matter of any one of Examples 1 to 9 may optionally include that, to derive the plurality of intents, the method or apparatus may identify intents on a path between the set of intents in the intent network.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for a recommendation system carried out by at least one processor, the method comprising:
receiving an expression;
extracting a set of intents from the expression;
deriving a plurality of intents based on an intent network and the set of intents, each node of the intent network representing an intent, each edge of the intent network representing a correlation between two intents corresponding to two nodes of the edge; and
making recommendations for the plurality of intents.

2. The method of claim 1, further comprising classifying the plurality of intents into one or more intent sets, wherein the making recommendations comprises determining a set of recommendations for each intent set of the one or more intent sets.

3. The method of claim 2, further comprising calculating a risk index for each set of recommendations.

4. The method of claim 1, wherein the plurality of intents comprises at least one of a set of direct intents or a set of indirect intents.

5. The method of claim 1, wherein the set of intents are extracted using one or more expression templates.

6. The method of claim 1, further comprising generating or updating the intent network based on an intent database and external sources, the external sources comprising at least one of Internet sites or digital literatures.

7. The method of claim 6, wherein the generating or updating the intent network comprises updating a weight for an edge of the intent network, the weight representing a degree of correlation between two intents corresponding to two nodes of the edge.

8. The method of claim 7, wherein the weight is calculated based on at least one of a frequency of the two intents on same or similar external source or a frequency of the two intents involved in same transaction.

9. The method of claim 1, wherein the deriving the plurality of intents comprises identifying intents connected to the set of intents in the intent network with a correlation value that satisfies a threshold.

10. The method of claim 1, wherein the deriving the plurality of intents comprises identifying intents on a path between the set of intents in the intent network.

11. An apparatus for a recommendation system, comprising:
a memory; and
at least one processor coupled to the memory and configured to:
receive an expression;
extract a set of intents from the expression;
derive a plurality of intents based on an intent network and the set of intents, each node of the intent network representing an intent, each edge of the intent network representing a correlation between two intents corresponding to two nodes of the edge; and
make recommendations for the plurality of intents.

12. The apparatus of claim 11, wherein the at least one processor is further configured to classify the plurality of intents into one or more intent sets, wherein, to make recommendations, the at least one processor is configured to determine a set of recommendations for each intent set of the one or more intent sets.

13. The apparatus of claim 12, wherein the at least one processor is further configured to calculate a risk index for each set of recommendations.

14. The apparatus of claim 11, wherein the at least one processor is further configured to generate or update the intent network based on an intent database and external sources, the external sources comprising at least one of Internet sites or digital literatures.

15. The apparatus of claim 14, wherein, to generate or update the intent network, the at least one processor is configured to update a weight for an edge of the intent network, the weight representing a degree of correlation between two intents corresponding to two nodes of the edge.
